(19) United States
(12) Patent Application Publication
(10) Pub. No.: US 2012/0260203 A1
(43) Pub. Date: Oct. 11, 2012

(54) ADAPTIVE DRAG AND DROP ZONE

(75) Inventors: Patrick M. Commarford, Louisville, KY (US); Susan K. McKinstry, Rucson, AZ (US); David J. Toth, Durham, NC (US)

(73) Assignee: International Business Machines Corporation, Armonk, NY (US)

(21) Appl. No.: 13/082,637

(22) Filed: Apr. 8, 2011

(51) Int. Cl. G06F 3/048

(52) U.S. Cl. 715/769

(57) ABSTRACT

A computer-implemented method for displaying an adaptive drag and drop zone in a user interface of software executing on the computer having at least one processor and a memory comprises: in response to a display of a drop zone, monitoring user interactions with the user interface, including initiation of a drag and drop events; and dynamically decreasing at least one of a size of the drop zone and any drop zone user assistance based on the user interactions.

### BACKGROUND

Drag and drop is a well-known method in computer systems by which users can execute some action by selecting a screen element and dragging the element to an eligible drop zone. For example, the Windows OS has long allowed users to perform a soft delete by dragging a file or folder to an icon representing a recycle bin.

Drag and drop is an efficient and beneficial feature, but is somewhat hidden from novice (and sometimes even experienced) users. This is particularly true when objects that are not typically associated with drop zones become available. In other words, users are likely to expect a recycle bin or a folder to be an eligible drop zone; however other screen elements typically do not behave as drop zones for some action For example, it is unclear if one can drag text to the “I” button in an MS Word™ menu to italicize it and it is also not clear whether many users have tried because there is nothing suggesting to that the “I” button is a drop zone.

Due to the hidden nature of some drop zones, it is sometimes necessary to provide the user with strong cues or embedded user assistance that a particular screen location is an eligible drop zone. Often times, dedicated screen space is required. This strategy works very well for certain types of applications and contexts. However, the strategy becomes problematic when screen real estate is at a premium (for example, in a side-bar context or in a mobile application). In such a context, as users build expertise, they begin to see this strategy as a greater and greater misuse of valuable screen space. So, while the trade-off of feature exposure for screen space may be helpful and even necessary for novice users; it can become burdensome for experts.

Accordingly, it would be desirable to provide an improved method and system for displaying a drag and drop zone.

### BRIEF SUMMARY

The exemplary embodiment provides methods and systems for method for displaying an adaptive drag and drop zone in a user interface. Aspects of exemplary environment include in response to a display of a drop zone, monitoring user interactions with the user interface, including initiation of a drag and drop events; and dynamically decreasing at least one of a size of the drop zone and any drop zone user assistance based on the user interactions.

### BRIEF DESCRIPTION OF SEVERAL VIEWS OF THE DRAWINGS

FIG. 1 is a logical block diagram illustrating an exemplary system environment for implementing one embodiment of an adaptive drag-and-drop zone.

FIG. 2 is a flow diagram illustrating one environment of a process for displaying an adaptive drag and drop zone in a user interface of software executing on the computer.

FIGS. 3A-3E are diagrams depicting an example life-cycle (from left-to-right, top-to-bottom) of a user interface of a sidebar window having an adaptive drop zone.

### DETAILED DESCRIPTION

The exemplary embodiment relates to method and system for displaying an adaptive drag and drop zone in a user interface. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide an adaptive drag and drop user interface by which the dedicated space and user assistance required for a drop zone dynamically changes based on user interaction. In such a case that screen real estate is valuable and limited, such as in a mobile device, a user interface (UI) may initially present to users a large drop-zone area with an optional text prompt (e.g., “Drop files here”) and an icon. Then, as users begin to demonstrate an understanding that this is a drop-zone, the drop-zone decreases in size over time. The exemplary embodiments hold a user's hands and bring the user to a point at which they can make use of a drop-zone that doesn't appear as a traditional drop target to conserve screen space.

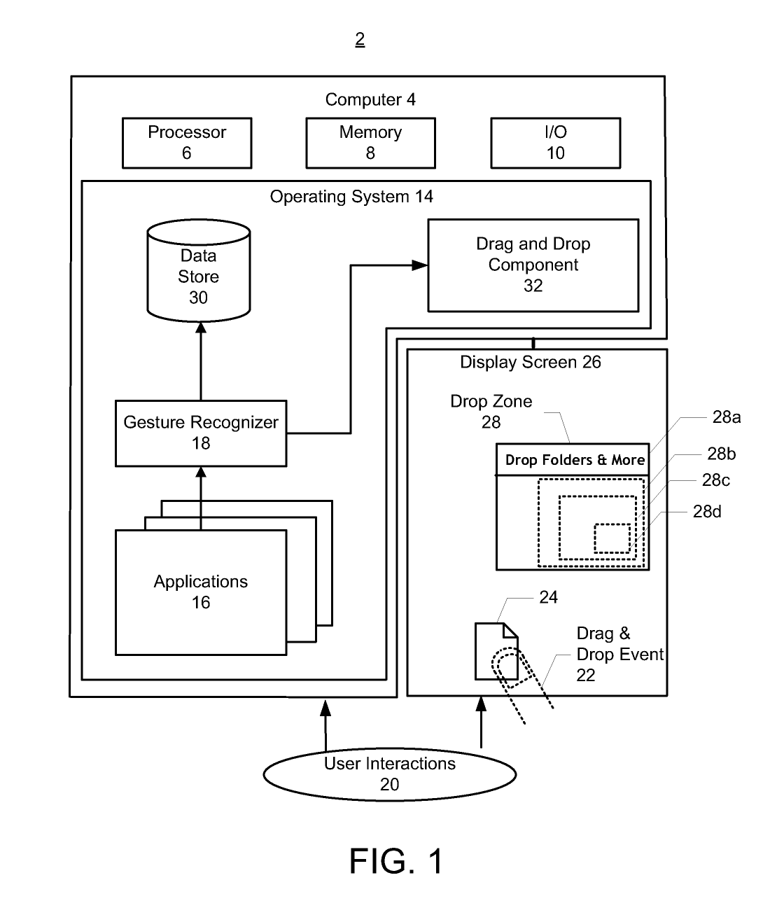

FIG. 1 is a logical block diagram illustrating an exemplary system environment for implementing one embodiment of an adaptive drag-and-drop zone. The system 2 includes a computer 4 having at least one processor 6, a memory 8, an input/output (I/O) 10, and a display screen 26 coupled together via a system bus (not shown). The computer 4 may exist in various forms, including a smart or mobile phone, a tablet computer, a personal computer (PC), (e.g., desktop, laptop, or notebook), a personal digital assistant (PDA), a set-top box, a game system, and the like. The computer 4 may include other hardware components of typical computing devices (not shown), including input devices (e.g., keyboard, pointing device, microphone for voice commands, buttons, touch screen, etc.), and output devices (e.g., speakers, and the like). The computer 4 may include computer-readable media, e.g., memory and storage devices (e.g., flash memory, hard drive, optical disk drive, magnetic disk drive, and the like) containing computer instructions that implement the functionality disclosed when executed by the processor. The computer 4 may further include wired or wireless network communication interfaces for communication.

The processor 6 may be part of data processing system suitable for storing and/or executing software code including an operating system 14 and various applications 16. The processor 6 may be coupled directly or indirectly to elements of the memory 8 through a system bus (not shown). The memory elements can include local memory employed during actual execution of the program code, bulk storage, and cache memories which provide temporary storage of at least some program code in order to reduce the number of times code must be retrieved from bulk storage during execution.

The input/output 10 or I/O devices (including but not limited to keyboards, displays, pointing devices, etc.) can be coupled to the system either directly or through intervening I/O controllers. Network adapters (not shown) may also be coupled to the system to enable the data processing system to become coupled to other data processing systems or remote printers or storage devices through intervening private or public networks. Modems, cable modems and Ethernet cards are just a few of the currently available types of network adapters.

The operating system 14 and/or the applications 16 (such as a web browser, a word processor, a photo/movie editor, and the like) are hereinafter referred to as “the software”. During execution of the software, a graphical user interface displays screen elements 24, such as an icon of a file or a text selection, on the display screen 26. A user interacts with the software with pointing devices, such as a mouse or stylus, and/or the software may be touch screen enabled, which enables control using a variety of pointing devices on the display screen 26, including the user's finger and various types of styluses.

A conventional gesture recognizer 18, which may be at part of the operating system 14 or incorporated into the applications 16, may receive user interactions 20 and in response determines gesture types, including a drag-and-drop event 22. A drag-and-drop event 22, also referred to as a drag-and-drop operation, is a common method for manipulating a screen element 24 within a graphical user interface environment.

At an initiation of a drag-and-drop event 22, a user moves a pointer (e.g., cursor or finger) over the screen element 24, and presses a mouse button, or in the case of a finger, may press and hold the finger on the display screen 26. The mouse button or finger is then held down while moving (i.e., dragging) the pointer and the screen element 24 to a drop zone 28 on the display screen 26 that represents a destination or target for the screen element 24, and then the user releases the button/finger to drop the file.

The drop zone 28 is typically initially displayed in a default size 28a that takes up dedicated screen space. On computers equipped with small displays, such as mobile devices, this approach poses problems when screen real estate is limited.

Accordingly, exemplary embodiments provide a data store 30 for tracking user interactions 20 such as drag-and-drop events 22, and a drag-and-drop component 32 that adaptively resizes the drop zone 28 based on the user interactions 20.

In one embodiment, the drag and drop component 32 is implemented as a software component, but in other embodiments, could be implemented as a combination of hardware and software. Although the gesture recognizer 18 and the drag-and-drop component 32 are shown as separate components, the functionality of each may be combined into a lesser or greater number of modules/components.

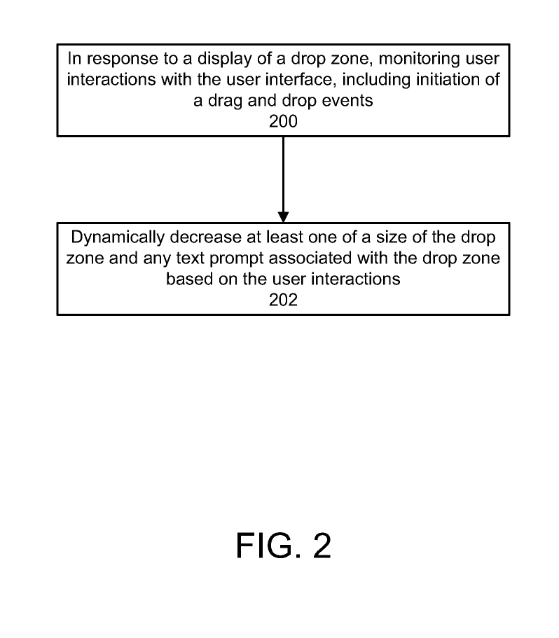

FIG. 2 is a flow diagram illustrating one environment of a process for displaying an adaptive drag and drop zone in a user interface of software executing on the computer. The process may begin by monitoring user interactions with the user interface, including initiation of a drag and drop events, in response to a display of a drop zone (block 200). In one embodiment, on a computer 4 where screen real estate is valuable and limited, the software is configured to present to the user an initial drop zone having a relatively default size 28a and optional user assistance, such as text (e.g., “Drop files here”) and/or graphics such as an icon. In one embodiment, the drop zone 28 may be implemented as a window, a frame, a folder, an icon or other suitable object.

In one embodiment, the gesture recognizer 18 may monitor the user interactions 20 by storing information regarding user initiated drag-and-drop events 22 in the data store 30. In an alternative embodiment, the drag-and-drop component 32 or the software that displays the user interface may be configured to monitor the user interactions 20. If the computer 4 includes user logins, then the drag-and-drop events 22 can be tracked in the data store 30 for each user.

The drag-and-drop component 32 dynamically decreases at least one of a size of the drop zone and any drop zone user assistance based on the user interactions (block 202). For example, as shown in FIG. 1 after the drop zone 20 is displayed in a default size 28a, the drop zone 28 may be increasingly reduced in size, shown as 28b, 28c, 28d, as the user begins to demonstrate an understanding (by using it correctly) that the UI includes a drop-zone. Thus the drop-zone 28 dynamically shrinks with use over time. At some stage, the text can also begin to diminish (e.g., to “Drop files . . . ” and then eventually to “Drop . . . ”), remaining paired with an icon. As the user continues to demonstrate the ability to recognize & use the smaller target, the drop zone 28 may get reduced to an icon only. In one embodiment, the drop zone 28 may be eventually shifted out of a dedicated space to nearby white-space where the icon plus a surrounding area remain a drop target.

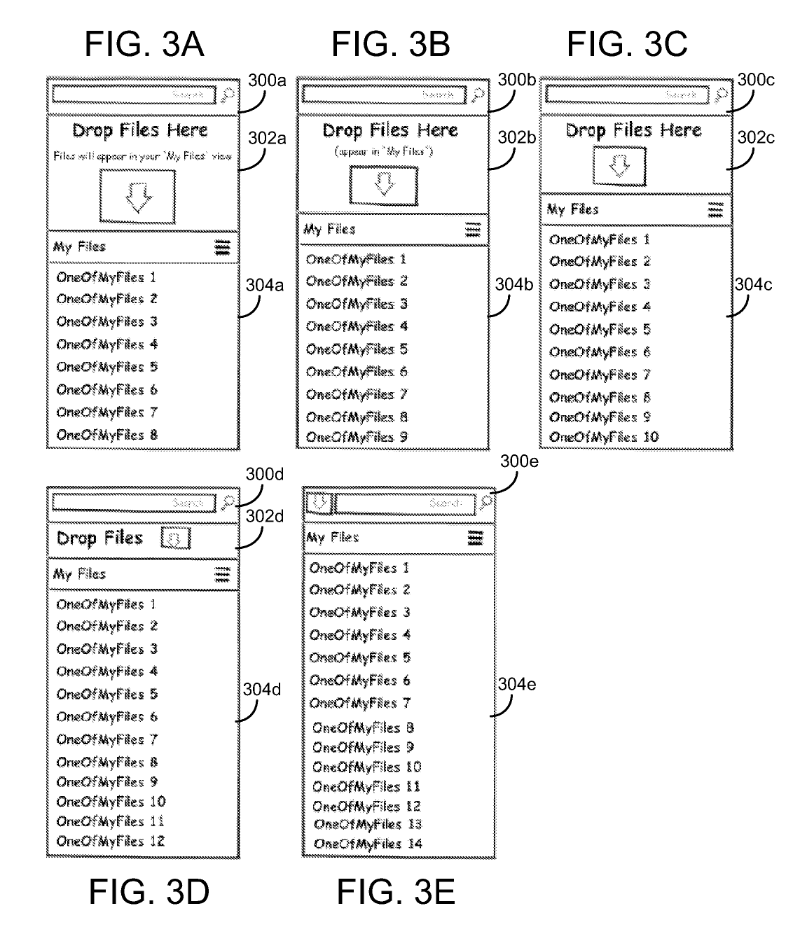

FIGS. 3A-3E are diagrams depicting an example life-cycle (from left-to-right, top-to-bottom) of a user interface of a sidebar window having an adaptive drop zone. FIG. 3A represents an initial state of the sidebar window 300a, which comprises an upper frame representing a drop zone 302a and a lower frame representing a directory window 304a of previously dropped files. In a mobile phone application, the sidebar window 300a may stand entire length of the mobile phone's display screen. The initial state of the drop zone 302a is designed to make clear that files can be dropped into a large target area, i.e., the box surrounding the text prompt “Drop Files Here” and the arrow icon. The large default or initial drop zone 302a aids users through the drop process, but comes at the sacrifice of space available to list previously dropped files. In this example, the default drop zone 302a leaves enough room to support the display of only eight files in the directory window 304a.

According to the exemplary embodiment, FIG. 3B shows that once a user executes a drag-and-drop of two or three files into the drop zone 302a, the drag-and-drop component 32 slightly decreases the size of the drop zone 302b from the initial size to provide less user assistance. This leaves more room for the display of files in the directory window 304b. FIGS. 3C and 3D show as more files are dropped, the size drop zones 302c and 302d, the text and icon therein are iteratively reduced. FIG. 3E shows that once a user has demonstrated expertise, e.g. based on the number of drag-and-drop events, the drop target can be eventually hidden or eliminated entirely from the sidebar window 300d, other than the cursor change on hover, to conserve even more vertical space. In the example, the directory window 304e has been increased in size to support the display of 14 files from an original 8.

As used herein, the drop zone is adaptive in that certain display characteristics including any combination of size, text and graphics are automatically resized overtime (i.e., dynamically) as the drag-and-drop component 32 observe changes in drag-and-drop events statistics the and compares the statistics to either preset or user configurable thresholds.

For example, the drag-and-drop component 32 may dynamically decrease the size of the drop zone and/or any user assistance text and graphics when a number of initiated drag-and-drop events 22 over a predetermined time exceeds a first threshold.

The drag-and-drop component 32 may dynamically decrease the size of the drop zone and/or any user assistance text and graphics when a ratio of drag-and-drop events versus other move events initiated by the user exceeds a second threshold. An example of another move event is when the user right clicks an object to bring up a context menu and selecting a “move” command from the context menu.

The drag-and-drop component 32 may dynamically decrease the size of the drop zone and/or any user assistance text and graphics when a number of successfully completed drag-and-drop events 22 exceeds a third threshold.

The drag-and-drop component 32 may also display the drop zone as an overlay when a number of drag-and-drop events exceeds a fourth threshold.

Correspondingly, the drag-and-drop component 32 may increase the size of the drop zone and/or any user assistance text and graphics when a number of user-initiated drag-and-drop events is less than a fifth threshold. For example, the drag-and-drop component 32 might specify that if eight consecutive files are loaded via another, less efficient, method (e.g., a right click move), the drop-zone should begin to grow until clearly-recognized by the user (however, in this case, it would likely be beneficial to offer users the option to continue to constrain the drop space). The drop-zone could also begin to grow or snap-back to its original amount of dedicated space if the software displaying the drop zone is used infrequently (e.g., a few times a month); thus acting as a reminder to users who have learned, but then forgotten about the capability.

Another alternative to the shrinking drop zone could be displaying the drop zone is an overlay with more drop zone details (e.g., details describing the effect of the drop) presented the first time on a drag-and-drop event, and subsequently only showing regular hover help (or a simple cursor change) on valid drop zones.

A method and system for method for displaying an adaptive drag and drop zone in a user interface has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A computer-implemented method for displaying an adaptive drag and drop zone in a user interface of software executing on the computer having at least one processor and a memory, comprising:
in response to a display of a drop zone, monitoring user interactions with the user interface, including initiation of a drag and drop events; and
dynamically decreasing at least one of a size of the drop zone and any drop zone user assistance based on the user interactions.

2. The method of claim 1 further comprising dynamically decreasing at least one of a size of the drop zone and any drop zone user assistance when a number of initiated drag-and-drop events over a predetermined time exceeds a first threshold.

3. The method of claim 2 further comprising dynamically decreasing at least one of a size of the drop zone and any drop zone user assistance when a ratio of drag-and-drop events versus other move events initiated by the user exceeds a second threshold.

4. The method of claim 2 further comprising dynamically decreasing at least one of a size of the drop zone and any drop zone user assistance when a number of successfully completed drag-and-drop events exceeds a third threshold.

5. The method of claim 2 further comprising displaying the drop zone as an overlay when a number of drag-and-drop events exceeds a fourth threshold.

6. The method of claim 1 further comprising increasing the at least one of a size of the drop zone and any drop zone user assistance in when at least one of a number of user-initiated drag-and-drop events is less than a fifth threshold and when the software displaying the drop zone is used infrequently.

7. An executable software product stored on a computer-readable medium containing program instructions for displaying an adaptive drag and drop zone in a user interface, the program instructions for:
in response to a display of a drop zone, monitoring user interactions with the user interface, including initiation of a drag and drop events; and
dynamically decreasing at least one of a size of the drop zone and any drop zone user assistance based on the user interactions.

8. The executable software product of claim 7 further comprising dynamically decreasing at least one of a size of the drop zone and any drop zone user assistance when a number of initiated drag-and-drop events over a predetermined time exceeds a first threshold.

9. The executable software product of claim 8 further comprising dynamically decreasing at least one of a size of the drop zone and any drop zone user assistance when a ratio of drag-and-drop events versus other move events initiated by the user exceeds a second threshold.

10. The executable software product of claim 8 further comprising dynamically decreasing at least one of a size of the drop zone and any drop zone user assistance when a number of successfully completed drag-and-drop events exceeds a third threshold.

11. The executable software product of claim 8 further comprising displaying the drop zone as an overlay when a number of drag-and-drop events exceeds a fourth threshold.

12. The executable software product of claim 7 further comprising increasing the at least one of a size of the drop zone and any drop zone user assistance in when at least one of a number of user-initiated drag-and-drop events is less than a fifth threshold and when the software displaying the drop zone is used infrequently.

13. A system, comprising:
a memory;
a processor coupled to the memory;
a software component executed by the processor that displays a user interface; and
a drag-and-drop component executed by the processor that is configured to:
in response to a display of a drop zone, monitor user interactions with the user interface, including initiation of a drag and drop events; and
dynamically decrease at least one of a size of the drop zone and any drop zone user assistance based on the user interactions.
